(19) United States
(12) Patent Application Publication
(10) Pub. No.: US 2025/0135336 A1
(43) Pub. Date: May 1, 2025

(54) METHOD, APPARATUS, ELECTRONIC DEVICE, MEDIUM AND PRODUCT OF CLOUD GAME CONTROL

(71) Applicant: Beijing Zitiao Network Technology Co., Ltd., Beijing (CN)

(72) Inventor: Zheng WANG, Beijing (CN)

(21) Appl. No.: 18/927,737

(22) Filed: Oct. 25, 2024

(30) Foreign Application Priority Data
Oct. 31, 2023 (CN) 202311435234.4

(51) Int. Cl. A63F 13/355; A63F 13/73; H04L 65/1069

(52) U.S. Cl. CPC A63F 13/355; A63F 13/73; H04L 65/1069

(57) ABSTRACT

The embodiments of the disclosure disclose a method, an apparatus, an electronic device, a storage medium and a product of cloud game control, and the method includes the steps: obtaining predetermined device information of a corresponding handheld device in response to obtaining a handle connection event each time; interacting with a target cloud game server to register the handheld device based on the predetermined device information, and determining a device management number for the handheld device that is successfully registered; and obtaining a handle operation event, and forwarding the handle operation event to the target cloud game server based on a device management number associated with the handle operation event, to implement corresponding cloud game operation control.

### CROSS-REFERENCE

This application claims priority to Chinese Patent Application No. 202311435234.4 filed on Oct. 31, 2023, and entitled “METHOD, APPARATUS, ELECTRONIC DEVICE, MEDIUM AND PRODUCT OF CLOUD GAME CONTROL”.

### FIELD

The embodiment of the present disclosure relates to the technical field of cloud computing, in particular to a method, an apparatus, an electronic device, a storage medium and a product of cloud game control.

### BACKGROUND

The cloud game is a game implementation scenario, which is implemented based on a way that local rendering is performed by obtaining the flow through audio and video on the local client when the cloud container runs, and the data exchange is realized between the terminal and cloud through the signaling channel. In a cloud game scene, many complex game scenes rely on a handle to control, and a cloud game service party needs to support a physical handle control capability.

However, in a game scene in which a client interacts with a cloud game terminal, only a single-handle control capability can be provided, and a game control requirement of a complex game scene cannot be met, such as a multi-role battle, a multi-role collaboration, and other game scenes.

### SUMMARY

The present disclosure provides a method, an apparatus, an electronic device, a storage medium and a product of cloud game control. One cloud game client can be supported to simultaneously connect and manage a plurality of handheld devices, the user can experience a multi-party collaborative game based on the same cloud game client, and the aim of expanding the cloud game scene is achieved.

In a first aspect, an embodiment of the present disclosure provides a method of cloud game control, including:
obtaining predetermined device information of a corresponding handheld device in response to obtaining a handle connection event each time;
interacting with a target cloud game server to register the handheld device based on the predetermined device information, and determining a device management number for the handheld device that is successfully registered;
obtaining a handle operation event, and forwarding the handle operation event to the target cloud game server based on a device management number associated with the handle operation event, to implement corresponding cloud game operation control:

In a second aspect, an embodiment of the present disclosure further provides an apparatus of cloud game control, including:
a handle connection detection module configured to obtain predetermined device information of a corresponding handheld device in response to obtaining a handle connection event each time;
a handle registration module configured to interact with a target cloud game server and register the handheld device based on the predetermined device information, and determine a device management number for the handheld device that is successfully registered;
a game control instruction obtaining module configured to obtain a handle operation event, and forward the handle operation event to the target cloud game server based on a device management number associated with the handle operation event, to implement corresponding cloud game operation control.

In a third aspect, an embodiment of the present disclosure further provides an electronic device, including:
one or more processors;
a storage device configured to store one or more programs;
when the one or more programs are executed by the one or more processors, the one or more processors are caused to implement the method of cloud game control according to any one of the embodiments of the present disclosure.

In a fourth aspect, an embodiment of the present disclosure further provides a storage medium including computer executable instructions that, when executed by a computer processor, are configured to perform the method of cloud game control according to any one of the embodiments of the present disclosure.

According to a fifth aspect, an embodiment of the present disclosure further provides computer-readable storage medium having a computer program stored thereon, wherein the computer program, when executed by a processor, implements the method of cloud game control according to any one of the embodiments of the present disclosure.

According to the embodiment of the present disclosure, predetermined device information of a corresponding handheld device is obtained in response to obtaining a handle connection event each time. By interacting with a target cloud game server to register the handheld device based on the predetermined device information, and determining a device management number for the handheld device that is successfully registered, different handles are distinguished. By obtaining a handle operation event, and forwarding the handle operation event to the target cloud game server based on a device management number associated with the handle operation event, to ensure that the operation control instructions of each handle can be accurately identified and to implement corresponding cloud game operation control. According to the technical solution provided by the embodiments of the present disclosure, the problem that the game scene is limited due to the limited access number of game handle, one cloud game client can be supported to simultaneously connect and manage a plurality of handheld devices, the user can experience a multi-party collaborative game based on the same cloud game client, and the aim of expanding the cloud game scene is achieved.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, and elements and elements are not necessarily drawn to scale.

FIG. 1 is a schematic flowchart of a method of cloud game control according to an embodiment of the present disclosure;

FIG. 2 is a schematic diagram of interaction between a cloud game client and a cloud game server according to an embodiment of the present disclosure:

FIG. 3 is a schematic flowchart of a method of cloud game control according to an embodiment of the present disclosure:

FIG. 4 is a schematic flowchart of a method of cloud game control according to an embodiment of the present disclosure:

FIG. 5 is a schematic flowchart of a cloud game control example according to an embodiment of the present disclosure:

FIG. 6 is a schematic structural diagram of an apparatus of cloud game control according to an embodiment of the present disclosure:

FIG. 7 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, and vice versa. It should be understood that the drawings and embodiments of the present disclosure are for exemplary purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprising” and deformation thereof are open-ended, i.e., “including but not limited to”. The term “based on” is “based at least in part on”. The term “one embodiment” means “at least one embodiment”: the term “another embodiment” means “at least one further embodiment”: the term “some embodiments” means “at least some embodiments”. The relevant definition of other terms will be given below.

It should be noted that concept concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that “one or more” should be understood unless the context clearly indicates otherwise.

It can be understood that, before the technical solutions disclosed in the embodiments of the present disclosure are used, the types of personal information related to the present disclosure, the usage scope, the usage scene and the like should be notified to the user in an appropriate manner according to the relevant laws and regulations and obtain the authorization of the user.

For example, in response to receiving an active request from a user, prompt information is sent to the user to explicitly prompt the user that the requested operation will need to obtain and use the personal information of the user. Therefore, the user can autonomously select whether to provide personal information to software or hardware executing the operation of the technical solution of the present disclosure according to the prompt information.

As an alternative but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations.

FIG. 1 is a schematic flowchart of a method of cloud game control according to an embodiment of the present disclosure.

As shown in FIG. 1, the method of cloud game control includes:

S110, obtain predetermined device information of a corresponding handheld device in response to obtaining a handle connection event each time.

In a cloud game scene, a user may control the cloud game by using an operation control on the cloud game client, and it may be understood as using an operation control on the client as a virtual game handle: or may also control the cloud game by connecting an external device such as a game handle to a client on which the cloud game client runs. Generally, each client can only support one handheld device (physical handheld device or virtual handheld device) to perform operation control on the cloud game. In the multi-role game scene, each of a plurality of clients respectively access a handheld device and interacts with the cloud game server to realize the multi-role game. For the cloud game server, the plurality of clients need to be connected to it at the same time, and data of the game audio and video are sent and rendered multiple times in the same scene.

In the embodiment, a cloud game client may support simultaneous access of a plurality of game handheld devices. The plurality of game handheld devices may be physical handheld devices, may also be virtual handheld devices, or a combination therebetween. Therefore, whenever a handle connection event is obtained, the predetermined device information of the corresponding handheld device is obtained, so that the plurality of handheld devices are distinguished in the subsequent recognition and forwarding process of the handle operation event.

In a feasible implementation, the handle connection event may be obtained through a predetermined handle connection event detection interface. The handle connection event detection interface may detect a handle connection event when obtaining the device connection signal or the virtual handle creation operation instruction of the predetermined physical interface. For example, when a physical handheld device is connected to the terminal device running the cloud game client through a USB interface or Bluetooth communication, the corresponding trigger is triggered to detect the invoking of the interface function, so that the cloud game client obtains a handle connection event.

When the handle connection event is obtained, the predetermined device information of the handheld device corresponding to the handle connection event may be obtained by invoking a parameter reading function or in other ways. The predetermined device information may include one or a combination of information such as a device index number, a device type (physical device or virtual device), a device name, a device vendor identifier, a device product number, and a device connection state (device insertion or extraction). When the device is a virtual handheld device, information such as a corresponding device vendor identifier and a product number may be omitted or represented by an executed symbol.

S120: interact with a target cloud game server to register the handheld device based on the predetermined device information, and determine a device management number for the handheld device that is successfully registered.

After obtaining the device information of the accessed handheld device, the cloud game client sends a registration request of the handheld device to the cloud game server, so that the operation instruction of the handheld device can be identified and distinguished during the subsequent cloud game operation.

When the cloud game server receives the handheld device registration request, it confirms that the handheld device is a trusted device based on the device information of the handheld device, and stores one piece of device information in the cloud. Further, the message of successful registration of the handheld device is fed back to the cloud game client.

After receiving the feedback information that the handheld device is successfully registered, the cloud game client may list the handheld device as the target management device, and determine the device management number. The device management number may be the trusted device management number that is generated based on the predetermined number rule, or the device index number corresponding to the handheld device may be directly used as the device management number. Based on the device management number, the cloud game client can distinguish different handheld devices, or can intercept and recognize the operation control instruction of the handheld device.

S130: obtain a handle operation event, and forward the handle operation event to the target cloud game server based on a device management number associated with the handle operation event, to implement corresponding cloud game operation control.

The handle operation event may be that the key of the handle is pressed, the joystick is pushed, or the positioning information of the handle is changed. The trigger of the handle operation event is associated with its corresponding handheld device, so the device management number of the corresponding handheld device can be obtained from the obtained handle operation event.

Further, the cloud game client may packet the obtained event information of the handle operation event based on the predetermined communication management protocol of the multi-handheld device and the corresponding device association number, and forward the information to the target cloud game server. Therefore, the target cloud game server can parse the handle operation event according to the predetermined protocol rule (the rule corresponding to the management communication protocol of the multi-handheld device), and add the control instruction corresponding to the parsing result to the corresponding cloud game process, that is, adding the operation instruction corresponding to the parsing result into the operating system running the target cloud game, to implement the cloud game operation control process. After parsing the handle operation event, the cloud game server may determine which operation instruction sent by the handle that has been registered successfully, so that a corresponding operation may be implemented.

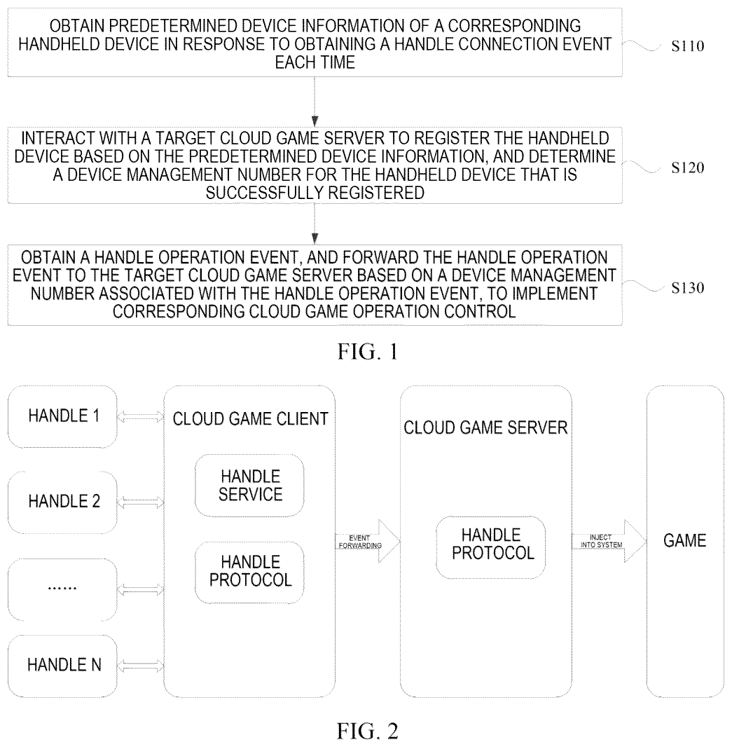

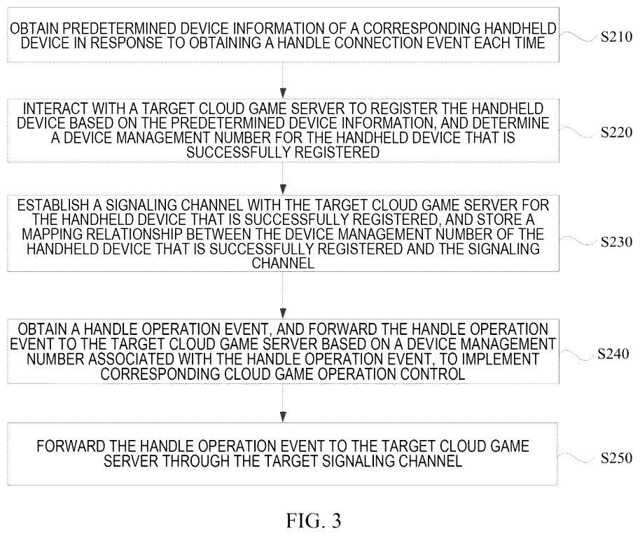

In a feasible embodiment, an interaction between the cloud game client and the cloud game server may refer to the interaction framework shown in FIG. 2. In FIG. 2, a cloud game client may support establishing a connection with N game handheld devices at the same time, to implement a predetermined handle service, such as monitoring and processing a connection state of a physical/virtual handle, registration/anti-registration of a handheld device, handheld device information management, device index information allocation, physical handle operation event interception, and the like. In addition, the cloud game client may also be responsible for forwarding the handle operation event packaged through the predetermined handle protocol, and processing message events such as device registration state change, where the message events are returned by the cloud game server. The handle protocol refers to a protocol module for handle communication between the cloud game client SDK and the cloud game server core service, for example, the protocol module is responsible for the protocol packaging and parsing of the event, including registration/anti-registration of a physical handle or a virtual handle, the handle key, the joystick of the handle. The cloud game server can parse the operation time of the handle based on the handle protocol to realize the operation of the game. In this embodiment, the cloud game may involve multi-person manipulation and a client game with multi-role for the third party.

According to the technical scheme of the embodiment of the present disclosure, predetermined device information of a corresponding handheld device is obtained in response to obtaining a handle connection event each time. By interacting with a target cloud game server to register the handheld device based on the predetermined device information, and determining a device management number for the handheld device that is successfully registered, different handles are distinguished. By obtaining a handle operation event, and forwarding the handle operation event to the target cloud game server based on a device management number associated with the handle operation event, to ensure that the operation control instructions of each handle can be accurately identified and to implement corresponding cloud game operation control. According to the technical solution provided by the embodiments of the present disclosure, the problem that the game scene is limited due to the limited access number of game handle, one cloud game client can be supported to simultaneously connect and manage a plurality of handheld devices, the user can experience a multi-party collaborative game based on the same cloud game client, and the aim of expanding the cloud game scene is achieved.

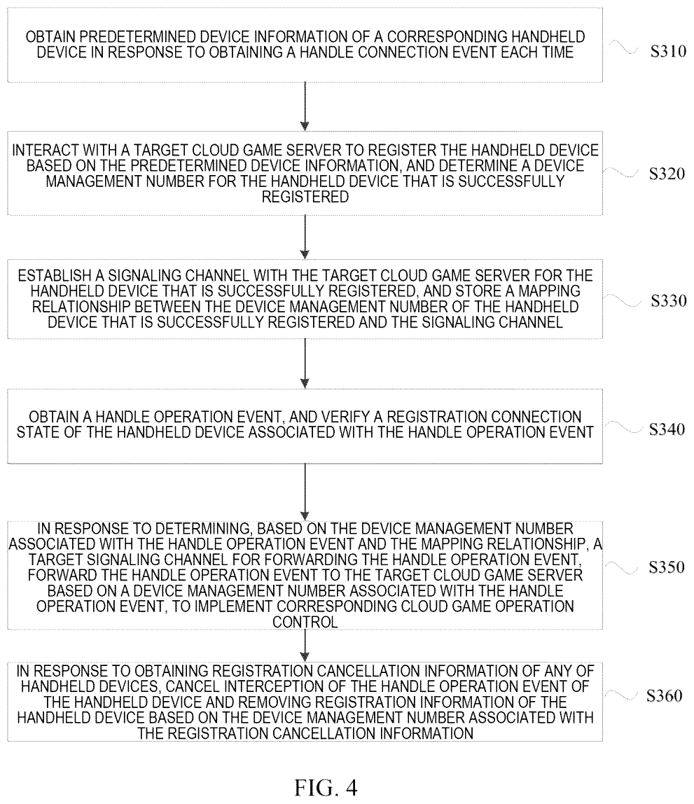

FIG. 3 is a schematic flowchart of still another method of cloud game control according to an embodiment of the present disclosure. The method may be performed by a cloud game control apparatus, and the apparatus may be implemented in a form of software and/or hardware, alternatively, implemented by using an electronic device, and the electronic device may be a mobile terminal, a PC terminal, a server, or the like.

As shown in FIG. 3, the method of cloud game control includes:

S210, obtain predetermined device information of a corresponding handheld device in response to obtaining a handle connection event each time.

S220: interact with a target cloud game server to register the handheld device based on the predetermined device information, and determine a device management number for the handheld device that is successfully registered.

S230: establish a signaling channel with the target cloud game server for the handheld device that is successfully registered, and store a mapping relationship between the device management number of the handheld device that is successfully registered and the signaling channel.

Specifically, in the embodiment, in order to realize the interaction between the game control instruction of the cloud game client and the cloud game server, a signaling channel between the cloud game server and each of the handheld devices may be established, respectively. For example, when there are 5 handheld devices connected to the cloud game client at the same time and the cloud game server is successfully registered, the cloud game client establishes 5 signaling channels with the cloud game server. Each signaling channel may use the device management number of the corresponding handheld device as the distinguishing information of each signaling channel, or may separately identify each signaling channel, thereby establishing the mapping relationship between the device management number and the signaling channel of the handheld device that is successfully registered.

S240: obtain a handle operation event, and determine, based on the device management number associated with the handle operation event and the mapping relationship, a target signaling channel for forwarding the handle operation event.

The mapping relationship between the device management number and the signaling channel may be stored in the cloud game client as a data table, and the target signaling channel is determined by searching a table when forwarding the operation event.

For the obtained handle operation event, the operation event can be forwarded through the dedicated signaling channel of the handheld device associated with the handle operation event, the information disorder between the plurality of handheld devices can be avoided, the handle operation event can be effectively responded to, the plurality of handheld devices can be accurately and efficiently managed, and the multi-role game can be smoothly controlled.

S250: forward the handle operation event to the target cloud game server through the target signaling channel, to implement corresponding cloud game operation control.

The cloud game client may encapsulate the obtained event information of the handle operation event based on the predetermined communication management protocol of the multi-handheld device and the corresponding device association number, and forward the encapsulated handle operation event to the target cloud game server through the target signaling channel. Therefore, the target cloud game server can parse the handle operation event according to the predetermined protocol rule (the rule corresponding to the management communication protocol of the multi-handheld device), and add the control instruction corresponding to the parsing result to the corresponding cloud game process, that is, inject the operation instruction corresponding to the parsing result into the operating system running the target cloud game, to implement the cloud game operation control process.

According to the technical scheme of the embodiment of the present disclosure, predetermined device information of a corresponding handheld device is obtained in response to obtaining a handle connection event each time: interacting with a target cloud game server is performed to register the handheld device based on the predetermined device information, and a device management number for the handheld device that is successfully registered is determined, to distinguish different handles: further a signaling channel with the target cloud game server is established for the handheld device that is successfully registered, and a mapping relationship between the device management number of the handheld device that is successfully registered and the signaling channel is stored: a handle operation event is obtained, and based on the device management number associated with the handle operation event and the mapping relationship, a target signaling channel for forwarding the handle operation event is determined: the handle operation event to the target cloud game server is forwarded, to implement corresponding cloud game operation control. According to the technical solution provided by the embodiments of the present disclosure, the problem that the game scene is limited due to the limited access number of game handle, one cloud game client can be supported to simultaneously connect and manage a plurality of handheld devices, the user can experience a multi-party collaborative game based on the same cloud game client, and the aim of expanding the cloud game scene is achieved.

FIG. 4 is a schematic flowchart of a method of cloud game control according to an embodiment of the present disclosure. The method may be performed by a cloud game control apparatus, and the apparatus may be implemented in a form of software and/or hardware, alternatively, implemented by using an electronic device, and the electronic device may be a mobile terminal, a PC terminal, a server, or the like.

As shown in FIG. 4, the method of cloud game control includes:

S310, obtain predetermined device information of a corresponding handheld device in response to obtaining a handle connection event each time.

S320: interact with a target cloud game server to register the handheld device based on the predetermined device information, and determine a device management number for the handheld device that is successfully registered.

S330: establish a signaling channel with the target cloud game server for the handheld device that is successfully registered, and store a mapping relationship between the device management number of the handheld device that is successfully registered and the signaling channel.

S340: obtain a handle operation event, and verify a registration connection state of the handheld device associated with the handle operation event.

After obtaining the handle operation event from the handheld device, the handle operation event may be intercepted in a way such as predetermining an event interception function. The registration connection state of the handheld device associated with the handle operation event is verified to prevent the operation event from the unregistered handle from being forwarded to the cloud game server to cause an abnormal operation response.

In some scenes, the handheld device may disconnect the connection or release the registration at the cloud game service to exit the control of the game. The operation event for the handheld device that is not in the registered connection state is not sent to the cloud game server.

S350, in response to determining, based on the device management number associated with the handle operation event and the mapping relationship, a target signaling channel for forwarding the handle operation event, forward the handle operation event to the target cloud game server based on a device management number associated with the handle operation event, to implement corresponding cloud game operation control.

S360: in response to obtaining registration cancellation information of any of handheld devices, cancel intercepting the handle operation event of the handheld device and removing registration information of the handheld device according to the device management number associated with the registration cancellation information.

It may be understood that the executing time of S360 may be any moment after any one of the handheld devices is registered, and is not limited to detecting a handle operation event.

When the plurality of handheld devices are connected to the cloud game client, any one of the handheld devices breaks down the connection with the cloud game client (the physical unplug or the operation exit instruction corresponding to the virtual handle), and triggers a registration cancellation event (anti-registration), and correspondingly, the cloud game client will obtain the registration cancellation information. Further, the handle operation event of the corresponding handheld device is canceled according to the registration cancellation message, the registration information of the handheld device is removed, and the redundant signaling channel and information exchange between the cloud game client and the cloud game server is reduced.

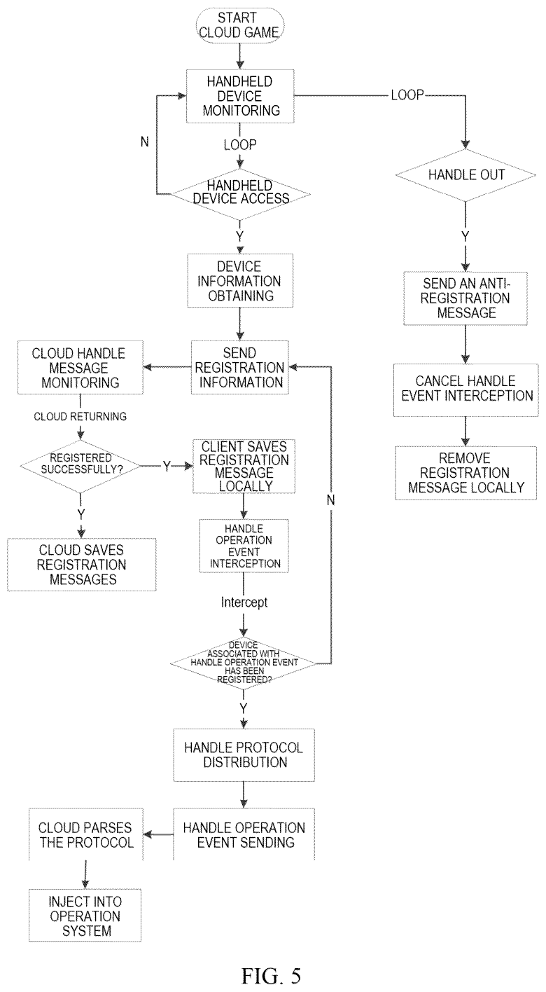

In a feasible implementation, the cloud game control process may refer to the flowchart shown in FIG. 5, and in FIG. 5, it indicates that after a multi-role game starts, the cloud game client may perform loop (LOOP) detection of the event of the handheld device insertion or the handle extraction until the occurrence of the corresponding event is detected. After the handheld device is inserted into the terminal device running the cloud game client, the device information of the handheld device is obtained. Further, a registration message is sent to the cloud game server (cloud container) based on the obtained information about the handheld device. After detecting the handle registration message, the cloud game server performs registration of the handle and returns a registration message. The registration message is stored in the cloud game server and the cloud game client after the handheld device is successfully registered. Further, the cloud game client may obtain and intercept the handle operation event, perform registration verification on the handheld device associated with the handle operation event, and forward the handle operation event to the cloud game server based on the handle protocol after verification succeeds. The cloud game server parses the handle operation event based on the handle protocol, adds the parsing result into the operating system, and responds to executing the corresponding operation instruction. When the handle is pulled out, the anti-registration message of the corresponding handheld device is sent to the cloud game server, the binding between the handheld device and the cloud game client is released, the corresponding handle operation event is cancelled, and the registration information corresponding to the handheld device is removed. Through the process, a cloud game client can support access of a plurality of handheld devices to realize multi-role game operation based on a single client.

According to the technical scheme of the embodiment of the present disclosure, predetermined device information of a corresponding handheld device is obtained in response to obtaining a handle connection event each time: interacting with a target cloud game server is performed to register the handheld device based on the predetermined device information, and a device management number for the handheld device that is successfully registered is determined, to distinguish different handles. A signaling channel with the target cloud game server for the handheld device that is successfully registered is determined, and a mapping relationship between the device management number of the handheld device that is successfully registered and the signaling channel is stored, a handle operation event is obtained, and a registration connection state of the handheld device associated with the handle operation event is verified. In response to determining, based on the device management number associated with the handle operation event and the mapping relationship, a target signaling channel for forwarding the handle operation event, the handle operation event is forwarded to the target cloud game server based on a device management number associated with the handle operation event, to implement corresponding cloud game operation control, to ensure that the operation control instructions of each handle can be accurately identified and to implement corresponding cloud game operation control. According to the technical solution provided by the embodiments of the present disclosure, the problem that the game scene is limited due to the limited access number of game handle, once cloud game client can be supported to simultaneously connect and manage a plurality of handheld devices, the user can experience a multi-party collaborative game based on the same cloud game client, and the aim of expanding the cloud game scene is achieved.

FIG. 6 is a cloud game control apparatus according to an embodiment of the present disclosure, the apparatus is applicable to a scene in which a cloud game runs, and in particular, a case in which a plurality of persons perform a game through cooperation of a same game client, the cloud game control apparatus may be implemented in a form of software and/or hardware, and may be configured on an electronic device, and the electronic device may be a mobile terminal, a PC terminal, a server, or the like.

As shown in FIG. 6, the apparatus of cloud game control includes: a handle connection detection module 410, a handle registration module 420, and a game control instruction obtaining module 430.

The handle connection detection module 410 is configured to, obtain predetermined device information of a corresponding handheld device in response to obtaining a handle connection event each time: a handle registration module 420 is configured to, interact with a target cloud game server and register the handheld device based on the predetermined device information, and determine a device management number for the handheld device that is successfully registered; and a game control instruction obtaining module 430 is configured to, obtain a handle operation event, and forward the handle operation event to the target cloud game server based on a device management number associated with the handle operation event, to implement corresponding cloud game operation control.

According to the technical scheme of the embodiment of the present disclosure, predetermined device information of a corresponding handheld device is obtained in response to obtaining a handle connection event each time. By interacting with a target cloud game server to register the handheld device based on the predetermined device information, and determining a device management number for the handheld device that is successfully registered, different handles are distinguished. By obtaining a handle operation event, and forwarding the handle operation event to the target cloud game server based on a device management number associated with the handle operation event, to ensure that the operation control instructions of each handle can be accurately identified and to implement corresponding cloud game operation control. According to the technical solution provided by the embodiments of the present disclosure, the problem that the game scene is limited due to the limited access number of game handle, one cloud game client can be supported to simultaneously connect and manage a plurality of handheld devices, the user can experience a multi-party collaborative game based on the same cloud game client, and the aim of expanding the cloud game scene is achieved.

In an alternative implementation, the handle registration module 420 may be further configured to:
establish a signaling channel with the target cloud game server for the handheld device that is successfully registered, and store a mapping relationship between the device management number of the handheld device that is successfully registered and the signaling channel.

In an alternative implementation, the game control instruction obtaining module 430 is specifically configured to:
determine, based on the device management number associated with the handle operation event and the map relationship, a target signaling channel for forwarding the handle operation event;
forward the handle operation event to the target cloud game server through the target signaling channel.

In an alternative implementation, the handle registration module 420 may be further configured to:
verify a registration connection state of the handheld device associated with the handle operation event.

In an alternative implementation, the handle connection detection module 410 is specifically configured to:
obtain the handle connection event, which includes:
obtaining the handle connection event in response to a device connection signal of a predetermined physical interface: or
obtaining the handle connection event in response to a virtual handle creation operation instruction.

In an alternative implementation, the handle registration module 420 is further configured to:
obtain registration cancellation information of any of handheld devices;
cancel interception of the handle operation event of the handheld device and removing registration information of the handheld device based on the device management number associated with the registration cancellation information.

In an alternative implementation, the game control instruction obtaining module 430 is specifically configured to:
forward the handle operation event to the target cloud game server to implement the corresponding cloud game operation control, which includes:
forwarding the handle operation event to the target cloud game server, to cause the target cloud game server to parse the handle operation event based on a predetermined protocol rule, and adding a control instruction corresponding to a parsing result to a corresponding cloud game process, to implement a cloud game operation control process.

The cloud game control apparatus provided by the embodiments of the present disclosure may execute the method of cloud game control provided by any embodiment of the present disclosure, and has functional modules and beneficial effects corresponding to the execution method.

It should be noted that the units and modules included in the foregoing apparatus are only divided according to the function logic, but are not limited to the foregoing division, as long as the corresponding functions can be implemented: in addition, the specific names of the functional units are merely for case of distinguishing, and are not intended to limit the protection scope of the embodiments of the present disclosure.

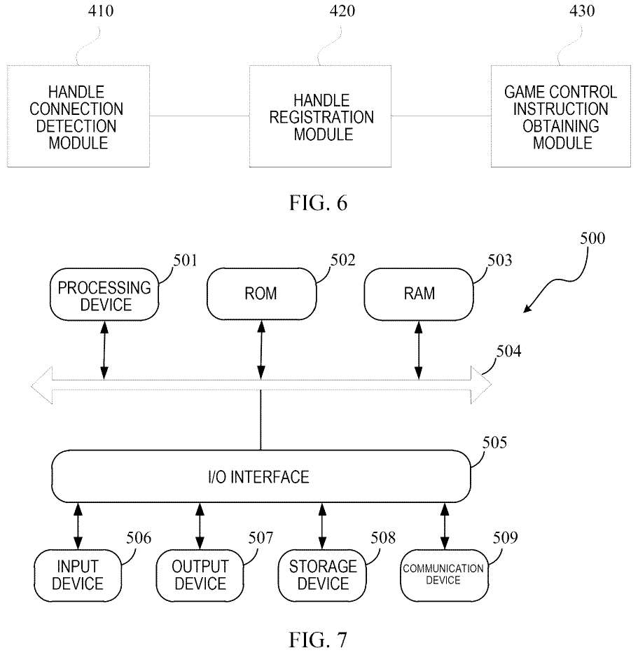

FIG. 7 is a schematic structural diagram of an electronic device according to an embodiment of the present disclosure. FIG. 7 is a schematic structural diagram of an electronic device (such as the terminal device or server in FIG. 7) suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 7 is merely an example, and should not impose any limitation on the functions and scope of use of the embodiments of the present disclosure.

As shown in FIG. 7, the electronic device 500 may include a processing device (for example, a central processing unit, a graphics processor, etc.) 501, which may perform various appropriate actions and processing according to a program stored in a read-only memory (ROM) 502 or a program loaded into a random access memory (RAM) 503 from a storage device 508. In the RAM 503, various programs and data required by the operation of the electronic device 500 are also stored. The processing device 501, the ROM 502, and the RAM 503 are connected to each other through a bus 504. An input/output (I/O) interface 505 is also connected to the bus 504.

Generally, the following devices may be connected to the I/O interface 505: an input device 506 including, for example, a touch screen, a touchpad, a keyboard, a mouse, a camera, a microphone, an accelerometer, a gyroscope, etc.: an output device 507 including, for example, a liquid crystal display (LCD), a speaker, a vibrator, etc.: a storage device 508 including, for example, a magnetic tape, a hard disk, etc.; and a communication device 509. The communication device 509 may allow the electronic device 500 to communicate wirelessly or wired with other devices to exchange data. While FIG. 7 shows an electronic device 500 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product comprising a computer program embodied on a non-transitory computer readable medium, the computer program comprising program code for performing the method shown in the flowchart. In such embodiments, the computer program may be downloaded and installed from the network through the communication device 509, or installed from the storage device 508, or from the ROM 502. When the computer program is executed by the processing apparatus 501, the foregoing functions defined in the method of the embodiments of the present disclosure are performed.

The names of messages or information interaction between the plurality of devices in embodiments of the present disclosure are for illustrative purposes only and are not intended to limit the scope of such messages or information.

The electronic device provided by the embodiments of the present disclosure and the method of cloud game control provided in the foregoing embodiments belong to the same inventive concept, technical details not described in detail in this embodiment may refer to the foregoing embodiments, and this embodiment has the same beneficial effects as the foregoing embodiments.

An embodiment of the present disclosure further provides a computer storage medium having a computer program stored thereon, the program, when executed by a processor, implements the method of cloud game control provided in the foregoing embodiments.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables. RF (radio frequency), and the like, or any suitable combination of the foregoing.

In some implementations, the client, server may communicate using any currently known or future developed network protocol, such as HTTP (HyperText Transfer Protocol), and may be interconnected with any form or medium of digital data communication (e.g., a communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be included in the electronic device: or may be separately present without being assembled into the electronic device.

The computer-readable medium carries one or more programs, and when the one or more programs are executed by the electronic device, the electronic device is caused to:
obtain predetermined device information of a corresponding handheld device in response to obtaining a handle connection event each time;
interact with a target cloud game server to register the handheld device based on the predetermined device information, and determine a device management number for the handheld device that is successfully registered;
obtain a handle operation event, and forwarding the handle operation event to the target cloud game server based on a device management number associated with the handle operation event, to implement corresponding cloud game operation control.

Computer program code for performing the operations of the present disclosure may be written in one or more programming languages, including, but not limited to, object oriented programming languages such as Java. Smalltalk. C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “obtaining at least two units of Internet Protocol addresses”.

The functions described above may be performed, at least in part, by one or more hardware logic components. For example, without limitation, exemplary types of hardware logic components that may be used, including: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic. infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), crasable programmable read-only memory (EPROM or Flash memory), optical fibers, portable compact disc read-only memory (CD-ROM), optical storage devices, magnetic storage devices, or any suitable combination of the foregoing.

An embodiment of the present disclosure further provides a computer program product, including a computer program, where the computer program, when executed by a processor, implements the method of cloud game control provided by any embodiment of the present disclosure.

The computer program product, during implementation, may write computer program code for performing the operations of the present disclosure in one or more programming languages, or a combination thereof, including an object oriented programming language, such as Java. Smalltalk. C++, and also conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

According to one or more embodiments of the present disclosure, a method of cloud game control is provided in Example 1. The method includes:
obtaining predetermined device information of a corresponding handheld device in response to obtaining a handle connection event each time;
interacting with a target cloud game server to register the handheld device based on the predetermined device information, and determining a device management number for the handheld device that is successfully registered;
obtaining a handle operation event, and forwarding the handle operation event to the target cloud game server based on a device management number associated with the handle operation event, to implement corresponding cloud game operation control.

According to one or more embodiments of the present disclosure, a method of cloud game control is provided in Example 2.

In some alternative implementations, the method further includes:
establishing a signaling channel with the target cloud game server for the handheld device that is successfully registered, and storing a mapping relationship between the device management number of the handheld device that is successfully registered and the signaling channel.

According to one or more embodiments of the present disclosure, a method of cloud game control is provided in Example 3.

In some alternative implementations, forwarding the handle operation event to the target cloud game server based on the device management number associated with the handle operation event includes:
determining, based on the device management number associated with the handle operation event and the mapping relationship, a target signaling channel for forwarding the handle operation event;
forwarding the handle operation event to the target cloud game server through the target signaling channel.

According to one or more embodiments of the present disclosure, a method of cloud game control is provided in Example 4.

In some alternative implementations, before forwarding the handle operation event, the method further includes:
verifying a registration connection state of the handheld device associated with the handle operation event.

According to one or more embodiments of the present disclosure, a method of cloud game control is provided in Example 5.

In some alternative implementations, obtaining the handle connection event includes:
obtaining the handle connection event in response to a device connection signal of a predetermined physical interface: or
obtaining the handle connection event in response to a virtual handle creation operation instruction.

According to one or more embodiments of the present disclosure, a method of cloud game control is provided in Example 6.

In some alternative implementations, the method further includes:
obtaining registration cancellation information of any of handheld devices;
canceling interception of the handle operation event of the handheld device and removing registration information of the handheld device based on the device management number associated with the registration cancellation information.

According to one or more embodiments of the present disclosure, a method of cloud game control is provided in Example 7.

In some alternative implementations, forwarding the handle operation event to the target cloud game server to implement the corresponding cloud game operation control includes:
forwarding the handle operation event to the target cloud game server, to cause the target cloud game server to parse the handle operation event based on a predetermined protocol rule, and adding a control instruction corresponding to a parsing result to a corresponding cloud game process, to implement a cloud game operation control process.

According to one or more embodiments of the present disclosure, an apparatus of cloud game control is provided in Example 8, the apparatus includes:
a handle connection detection module configured to obtain predetermined device information of a corresponding handheld device in response to obtaining a handle connection event each time;
a handle registration module configured to interact with a target cloud game server and register the handheld device based on the predetermined device information, and determine a device management number for the handheld device that is successfully registered;
a game control instruction obtaining module configured to obtain a handle operation event, and forward the handle operation event to the target cloud game server based on a device management number associated with the handle operation event, to implement corresponding cloud game operation control.

According to one or more embodiments of the present disclosure, a cloud game control apparatus is provided in Example 9.

In an alternative implementation, the handle registration module may be further configured to:
establish a signaling channel with the target cloud game server for the handheld device that is successfully registered, and store a mapping relationship between the device management number of the handheld device that is successfully registered and the signaling channel.

According to one or more embodiments of the present disclosure, an apparatus of cloud game control is provided in Example 10.

In an alternative implementation, the game control instruction obtaining module is specifically configured to:
determine, based on the device management number associated with the handle operation event and the mapping relationship, a target signaling channel for forwarding the handle operation event;
forward the handle operation event to the target cloud game server through the target signaling channel.

According to one or more embodiments of the present disclosure, an apparatus of cloud game control is provided in Example 11.

In an alternative implementation, the handle registration module may be further configured to:
verify a registration connection state of the handheld device associated with the handle operation event.

According to one or more embodiments of the present disclosure, an apparatus of cloud game control is provided in Example 12.

In an alternative implementation, the handle connection detection module is specifically configured to:
obtain a handle connection event, which includes:
obtaining the handle connection event in response to a device connection signal of a predetermined physical interface: or
obtaining the handle connection event in response to a virtual handle creation operation instruction.

According to one or more embodiments of the present disclosure, an apparatus of cloud game control is provided in Example 13.

In an alternative implementation, the handle registration module is further configured to:
obtain registration cancellation information of any of handheld devices;
cancel interception of the handle operation event of the handheld device and removing registration information of the handheld device based on the device management number associated with the registration cancellation information.

According to one or more embodiments of the present disclosure, an apparatus of cloud game control is provided in Example 14.

In an alternative implementation, the game control instruction obtaining module is specifically configured to:
forward the handle operation event to the target cloud game server to implement the corresponding cloud game operation control, which includes:
forward the handle operation event to the target cloud game server, to cause the target cloud game server to parse the handle operation event based on a predetermined protocol rule, and adding a control instruction corresponding to a parsing result to a corresponding cloud game process, to implement a cloud game operation control process.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in the plurality of embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

I/We claim:

1. A method of cloud game control, implemented at a cloud game client, comprising:
obtaining predetermined device information of a corresponding handheld device in response to obtaining a handle connection event each time;
interacting with a target cloud game server to register the handheld device based on the predetermined device information;
determining a device management number for the handheld device that is successfully registered; and
obtaining a handle operation event, and forwarding the handle operation event to the target cloud game server based on a device management number associated with the handle operation event, to implement corresponding cloud game operation control.

2. The method of claim 1, further comprising:
establishing a signaling channel with the target cloud game server for the handheld device that is successfully registered, and storing a mapping relationship between the device management number of the handheld device that is successfully registered and the signaling channel.

3. The method of claim 2, wherein forwarding the handle operation event to the target cloud game server based on the device management number associated with the handle operation event comprises:
determining, based on the device management number associated with the handle operation event and the mapping relationship, a target signaling channel for forwarding the handle operation event; and
forwarding the handle operation event to the target cloud game server through the target signaling channel.

4. The method of claim 1, wherein before forwarding the handle operation event, the method further comprises:
verifying a registration connection state of the handheld device associated with the handle operation event.

5. The method of claim 1, wherein obtaining the handle connection event comprises:
obtaining the handle connection event in response to a device connection signal of a predetermined physical interface: or
obtaining the handle connection event in response to a virtual handle creation operation instruction.

6. The method of claim 1, further comprising:
obtaining registration cancellation information of any of handheld devices; and
canceling interception of the handle operation event of the handheld device and removing registration information of the handheld device based on the device management number associated with the registration cancellation information.

7. The method of claim 1, wherein forwarding the handle operation event to the target cloud game server to implement the corresponding cloud game operation control comprises:
forwarding the handle operation event to the target cloud game server, to cause the target cloud game server to parse the handle operation event based on a predetermined protocol rule, and adding a control instruction corresponding to a parsing result to a corresponding cloud game process, to implement a cloud game operation control process.

8. An electronic device, comprising:
one or more processors; and
a storage device configured to store one or more programs;
wherein when the one or more programs are executed by the one or more processors, the one or more processors are caused to perform acts comprising:
obtaining predetermined device information of a corresponding handheld device in response to obtaining a handle connection event each time;
interacting with a target cloud game server to register the handheld device based on the predetermined device information;
determining a device management number for the handheld device that is successfully registered; and
obtaining a handle operation event, and forwarding the handle operation event to the target cloud game server based on a device management number associated with the handle operation event, to implement corresponding cloud game operation control.

9. The electronic device of claim 8, wherein the acts further comprise:
establishing a signaling channel with the target cloud game server for the handheld device that is successfully registered, and storing a mapping relationship between the device management number of the handheld device that is successfully registered and the signaling channel.

10. The electronic device of claim 9, wherein forwarding the handle operation event to the target cloud game server based on the device management number associated with the handle operation event comprises:
determining, based on the device management number associated with the handle operation event and the mapping relationship, a target signaling channel for forwarding the handle operation event; and
forwarding the handle operation event to the target cloud game server through the target signaling channel.

11. The electronic device of claim 8, wherein before forwarding the handle operation event, the acts further comprise:
verifying a registration connection state of the handheld device associated with the handle operation event.

12. The electronic device of claim 8, wherein obtaining the handle connection event comprises:
obtaining the handle connection event in response to a device connection signal of a predetermined physical interface: or
obtaining the handle connection event in response to a virtual handle creation operation instruction.

13. The electronic device of claim 8, wherein the acts further comprise:
obtaining registration cancellation information of any of handheld devices; and
canceling interception of the handle operation event of the handheld device and removing registration information of the handheld device based on the device management number associated with the registration cancellation information.

14. The electronic device of claim 8, wherein forwarding the handle operation event to the target cloud game server to implement the corresponding cloud game operation control comprises:
forwarding the handle operation event to the target cloud game server, to cause the target cloud game server to parse the handle operation event based on a predetermined protocol rule, and adding a control instruction corresponding to a parsing result to a corresponding cloud game process, to implement a cloud game operation control process.

15. A non-transitory computer-readable storage medium having a computer program stored thereon, wherein the computer program, when executed by a processor, implements acts comprising:
obtaining predetermined device information of a corresponding handheld device in response to obtaining a handle connection event each time;
interacting with a target cloud game server to register the handheld device based on the predetermined device information, and;
determining a device management number for the handheld device that is successfully registered; and
obtaining a handle operation event, and forwarding the handle operation event to the target cloud game server based on a device management number associated with the handle operation event, to implement corresponding cloud game operation control.

16. The non-transitory computer-readable storage medium of claim 15, wherein the acts further comprise:
establishing a signaling channel with the target cloud game server for the handheld device that is successfully registered, and storing a mapping relationship between the device management number of the handheld device that is successfully registered and the signaling channel.

17. The non-transitory computer-readable storage medium of claim 16, wherein forwarding the handle operation event to the target cloud game server based on the device management number associated with the handle operation event comprises:
determining, based on the device management number associated with the handle operation event and the mapping relationship, a target signaling channel for forwarding the handle operation event; and
forwarding the handle operation event to the target cloud game server through the target signaling channel.

18. The non-transitory computer-readable storage medium of claim 15, wherein before forwarding the handle operation event, the acts further comprise:
verifying a registration connection state of the handheld device associated with the handle operation event.

19. The non-transitory computer-readable storage medium of claim 15, wherein obtaining the handle connection event comprises:
obtaining the handle connection event in response to a device connection signal of a predetermined physical interface; or
obtaining the handle connection event in response to a virtual handle creation operation instruction.

20. The non-transitory computer-readable storage medium of claim 15, wherein the acts further comprise:
obtaining registration cancellation information of any of handheld devices; and
canceling interception of the handle operation event of the handheld device and removing registration information of the handheld device based on the device management number associated with the registration cancellation information.
